(19) United States
(12) Patent Application Publication
(10) Pub. No.: US 2006/0174111 A1
(43) Pub. Date: Aug. 3, 2006

(54) Method and system for electronic communication risk management

(76) Inventor: Paul Edward Burns, Scottsdale, AZ (US)

Correspondence Address: Paul E. Burns, P.O. Box 6612, Scottsdale, AZ, 85261, US

(21) Appl. No.: 11/220,366

(22) Filed: Sep. 6, 2005

Related U.S. Application Data
(60) Provisional application No. 60/608,312, filed on Sep. 8, 2004.

(51) Int. Cl. H04L 9/00

(52) U.S. Cl. 713/166

(57) ABSTRACT

A method and system for electronic communication risk management through implementation of rule sets that impose electronic communication limitation options on electronic communications that meet the criteria for inclusion in an electronic communication risk level category. One such electronic communication limitation option gives an electronic communication a temporal life span after which it is automatically deleted from memory locations in which a copy of it is electronically stored. A second limitation option precludes an intended recipient from forwarding, copying, and/or printing the received EC. A third limitation option blocks electronic communications from being sent to certain recipients until prior authorization is obtained. The invention reduces the risks associated with electronic communication proliferation and inadequately managed electronic communications.

### CROSS-REFERENCE TO RELATED APPLICATION

This application claims the benefit of U.S. Provisional Application No. 60/608,312, filed Sep. 8, 2004.

### BACKGROUND OF THE INVENTION

1. Field of the Invention

This invention concerns the field of electronic communication risk management.

2. Related Art

Electronic communications (“ECs”), such as electronic mail (“e-mail”), have revolutionized interpersonal communications. Over the past decade, ECs have become the dominant means of communication in the United States and in many countries throughout the world.

The evolution of ECs from their initial use by academic computer scientists to their widespread use via the Internet has fostered a unique culture of informality not seen in traditional paper correspondence. Moreover, the increasing availability, familiarity, efficiency and economy of ECs have resulted in the proliferation of ECs on orders of magnitude beyond any level imaginable when EC technology was first developed.

The pervasive use of ECs, especially e-mail, has not only revolutionized business and personal communications, but has brought with it a overwhelming and insurmountable management problem to senders, recipients and their employers. Presently, it is all too common for electronic communications to be (a) disseminated to unintended recipients, (b) deleted when they should be saved in a secure location, and (c) saved, often in numerous places, when they should be deleted.

The inability of senders, recipients and their employers to effectively manage electronic communications exposes them to grave risks that include (a) the creation of unintended legal obligations and/or legal liability that can result in (i) catastrophic monetary losses, (ii) termination of the right and/or ability to continue to do business, and (iii) in some cases, criminal liability, (b) irreparable harm to interpersonal relationships among employees, and with business associates, clients and customers, suppliers, friends, acquaintances and even family members who received electronic communications that they should not receive, and (c) increased costs of maintaining adequate electronic communication transmission bandwidth and storage capacity.

The ever-increasing number of persons who use ECs to communicate (hereinafter referred to as “EC users”), and the organizations for which they work, face the overwhelming challenge of managing and organizing immense volumes of ECs. It is common for EC users to accumulate hundreds, and even thousands, of e-mails in their e-mail inboxes without deleting unneeded e-mails or saving needed e-mails in any logical electronic filing system. Conversely, it is common for organizations to run “janitor” programs that implement automatic e-mail deletion after a certain number of days (usually anywhere from 30 to 90 days). E-mails that should be kept as organization records are often unintentionally deleted due to individuals' failure to save them electronically and/or in hard copy.

Standard e-mail programs comprise features that enable users to implement a limited set of rules that can automatically apply to incoming and/or saved e-mail. For example, Microsoft Outlook enables a user to automatically direct incoming e-mails containing certain user-designated key words to a pre-designated e-mail folder. Virtually all e-mail programs enable the user to block incoming e-mails from certain user-designated e-mail addresses. When users seek to retrieve a particular e-mail, standard e-mail programs enable sorting by sender, date and/or subject line. In addition, standard e-mail programs allow the user to retrieve e-mails containing particular words or phrases by employing standard text search technology. While these e-mail program features can assist users in organizing and retrieving e-mails, they have not had a significant impact on the pervasive problem of unbridled EC proliferation.

EC proliferation refers to ECs (and copies of ECs), or portions thereof, that should not exist. These EC's and copies of ECs that should not exist can generally fall under three broad categories. The first type concerns ECs that continue to exist beyond their useful life. The second type concerns ECs that should never have been created and sent. The third type concerns ECs that should not have been disseminated to particular recipients.

EC proliferation silently drains organization resources in several ways, including, but not limited to, (a) increased bandwidth costs, (b) increased storage costs, (c) increased processor costs, and (d) increased time and costs of retrieving ECs. The most serious problems caused by EC proliferation are often manifested when an organization finds itself involved in a dispute that matures into litigation. EC proliferation can greatly increase the cost of litigation, as well as increase the risk and amount of liability exposure to the organization.

When litigation becomes reasonably anticipated, an organization will have an obligation to retain and produce all relevant ECs. There are many ways that all three types of EC proliferation can cause disastrous consequences. For example, an individual makes a facetious oral statement that, accompanied by non-verbal cues, is properly received by the recipient in person as it was intended. That same statement, written in an e-mail that is unwittingly retained and must be produced in a litigation matter, is interpreted by the opposing party, and ultimately by the fact finder, as reflecting the author's actual state of mind, resulting in a large money judgment against the company. This is an example of Type 1 EC proliferation, an e-mail that was saved beyond its useful life.

An example of Type 2 EC proliferation, an e-mail that should not have been created and sent, would be an employee purporting to accept a vendor's proposal to provide goods or services to the organization without getting prior approval of an authorized officer of the organization. The e-mail, improperly sent outside the organization without authorization, creates a legal obligation on the part of the organization to pay for unnecessary goods or services. A similar example would involve an e-mail sent by a newly disgruntled employee to his or her counterpart at the organization's client setting forth his erroneous opinion that his employer was responsible for a bad result on a project, thus exposing his employer to legal liability and damage to its reputation.

The most potentially serious form of EC proliferation, Type 3, results from the ease with which intended recipients can, intentionally or unintentionally, forward ECs to unintended recipients. An example of Type 3 EC proliferation would be a confidential e-mail subject to the attorney/client privilege sent from an organization's legal counsel to its human resources director and the employee's supervisor addressing the organization's potential liability exposure applicable to a certain employee's sexual harassment claim, which is subsequently forwarded to the employee by the supervisor presumably to discourage the employee from filing a formal claim. The e-mail results in the organization having to pay a substantial sum of money to settle the employee's claims.

EC proliferation can cause potentially catastrophic security breaches. A Type 3 example would be where an employee intends to forward an e-mail containing highly classified information to a co-worker with appropriate security clearance, but accidentally hits “send” with a similarly spelled, erroneous recipient name in the “to” line. Another employee, upset about having been passed over for promotion, forwards confidential e-mails to his employer's competitor in an effort to secure a new position with the competitor. Indeed, these same examples of security breaches can also occur with respect to Type 2 EC proliferation, ECs that should never have been created and sent, such as where the disgruntled employee in the last example himself creates an e-mail containing confidential information and sent it to the competitor.

Examples of EC proliferation exist that do not fall squarely within the three broad categories described above. Moreover, there are qualitative distinctions that can be made within each of those defined categories. Suffice it to say, however, the three categories described cover the great majority of cases of EC proliferation.

The prior art has attempted to deal with certain aspects of unauthorized dissemination of ECs through the use of various security devices such as network firewalls, password access, and encryption. However, this prior art only applies to unauthorized persons who actively attempt to access such electronic communications by attempting to gain unauthorized access to a restricted-access computer server or network. The prior art does not adequately manage electronic communications generated and/or received by authorized users.

Similarly, the prior art does not presently solve the problem of effectively managing the unwarranted deletion or the unnecessary saving of ECs. For example, e-mail programs currently enable users to provide for e-mail contained in their “Inbox” or in other defined logical folders or files to be deleted after a certain number of days. Such programs do not, however, enable an author to designate a particular e-mail for deletion after a predetermined period of time, nor do they enable an author's employer or other authority to capture and save an important e-mail that should be saved if the sender decides to delete it.

Accordingly, what is needed is a method and system of Electronic Communication Risk Management (“ECRM”) that will mitigate the risks created by EC proliferation.

### SUMMARY OF THE INVENTION

The invention solves the problems set forth above not addressed by the prior art by providing a novel method and system of EC risk management that empowers the EC author, and/or the author's employer or other authority, to reduce the risks associated with inadequately managed ECs.

The invention provides for application of one or more rule sets to one or more ECs or categories of ECs. In one embodiment, the rule set may apply to one or more EC risk level categories to which ECs may be assigned. In that embodiment, each risk level category has a predetermined set of one or more rules assigned to it, referred to herein as a “risk level rule set”. The risk level rule set applies to all ECs categorized within the applicable risk level category. When a particular risk level rule set is applied to an EC, that EC is configured to comply with the rules contained within that risk level rule set.

The rules contained in a risk level rule set are designed to reduce the risks associated with the particular EC risk category to which the rules are assigned. From time to time, particular risk level categories and their corresponding risk level rule sets may be modified, new risk level categories and risk level rule sets assigned to them may be created, and existing risk level categories and corresponding risk level rule sets may be retired.

An exemplary embodiment of the present invention addresses the problem of unmitigated EC proliferation through implementation of rule sets that impose certain, predetermined limitations on ECs that meet the criteria for inclusion in a predetermined EC risk level category. In this embodiment, one or more EC limitation options (hereinafter referred to as “EC Limitation Options” or “ECLOs”) may be selected and applied to ECs. Some EC Limitation Options may be selected by the author or sender of an EC, other ECLOs may be selected by an individual with authority to impose such selected limitations on ECs authored or sent by one or more users within an organization. Various examples of ECLOs encompassed within this exemplary embodiment of the invention are summarized below.

One ECLO gives an EC a pre-determined temporal life span (hereinafter referred to as “EC-Temp”). EC-Temp permits a specified time period (“the EC Temporal Life” or “ECTL”) to be assigned to the EC from the time that it is created or sent, after which the EC is automatically deleted from at least one, and as many as all, of the memory locations in which a copy of the EC is electronically stored by a recipient and/or a sender. In other words, after the expiration of the ECTL, the EC can no longer be perceived by a user from any electronic memory storage medium upon which it was previously stored. In the preferred embodiment, the storage location of all copies of each portion of the EC is overwritten so that the EC could never be retrieved, recovered or restored using forensic software or any other data recovery method.

Another ECLO known as “EC-One” precludes an intended recipient from forwarding, copying, and/or printing the received EC. In one embodiment, the intended recipient can request the sender to grant the intended recipient authority to perform one or more of the proliferating acts, and the sender can decide to grant such authority.

Another ECLO blocks ECs from being sent outside a certain pre-determined domain until certain pre-determined conditions are met (hereinafter referred to as “EC-Block”). For example, an organization may utilize EC-Block to prevent employees from sending ECs outside of the organization. In a preferred embodiment, the employee may electronically request authority to send an EC to one or more recipients outside the organization from one or more superiors who have the option of reviewing the communication before deciding whether or not to grant the request. After such a request is granted, the employee is then permitted to send the EC to the intended recipient outside of the organization with a copy to the authorizing superior and potentially other designated copy recipients.

There are numerous variations in the described ECLOs that are within the scope and spirit of the present invention. The invention contemplates additional ECLOs that assist in managing the risks of the negative consequences of EC proliferation, as well as other problems associated with EC risk management and ECs in general.

In an exemplary embodiment, ECLOs are implemented through software instructions attached or otherwise directly or indirectly electronically connected to, or called by, the initially created copy, as well as each subsequently created copy, of the EC to which it applies. In one embodiment, the software instructions implementing the ECLOs are self-executing; they do not have to be activated or launched by a subsequent action after the EC is sent to a recipient. Moreover, in the preferred embodiment, the software instructions implementing the ECLOs cannot be altered or deleted by anyone except for the author, system administrator or other authority that initially implemented the ECLO.

### BRIEF DESCRIPTION OF THE SEVERAL VIEWS OF THE DRAWINGS

The present invention is further described in the detailed description which follows, in reference to the noted plurality of drawings by way of non-limiting examples of certain embodiments of the present invention, in which like numerals represent like elements throughout the several of the drawings, and wherein:

FIG. 1 is a flow chart depicting the process of establishing an EC risk level category;

FIG. 2 is a flow chart depicting an embodiment of the E-Temp ECLO.

FIG. 3 is a flow chart depicting an embodiment of the EC-One ECLO.

FIG. 4 is a flow chart depicting an embodiment of the EC-Block ECLO.

FIG. 5 is block diagram showing the various components of an embodiment of a system that implements an ECLO.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

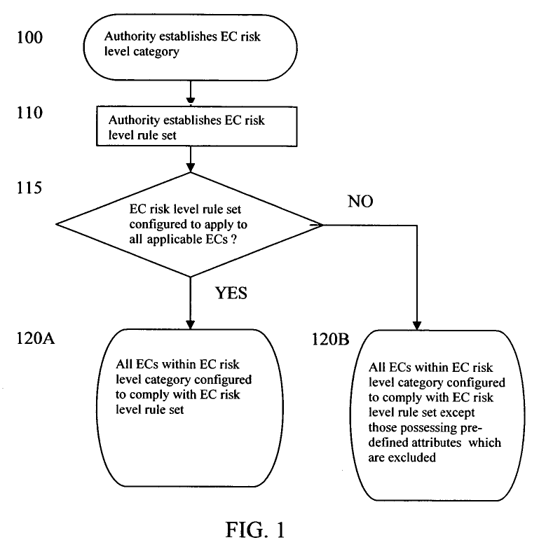

FIG. 1 is a flow chart depicting the process of establishing an EC risk level category. At Step 100, an authority establishes an electronic communication (“EC”) risk level category. By way of example, without limitation, an authority can be an individual user, a business entity, an association of individual users and/or business entities, or a system administrator. Step 110 shows an EC risk level rule set is established. At step 115, the authority decides whether the EC risk level rule set applies to all ECs that satisfy the criteria of the EC risk level category, or whether particular ECs possessing certain predefined attributes should be excluded from application of the risk level rule set, Step 115. At step 120A, when a particular risk level rule set applies to an EC, that EC is configured to comply with the rules contained within that risk level rule set. At Step 120B, if certain ECs possess predefined attributes, they will be excluded from application of the risk level rule set's limitations. The quantity and attributes of EC risk level categories and their corresponding risk level rule sets will vary depending upon the applicable environment.

An exemplary embodiment of the present invention addresses the problem of unmitigated EC proliferation through implementation of risk level rule sets that impose certain, predetermined limitations on ECs. In this embodiment, the risk level rule sets contain one or more EC limitation options (hereinafter referred to as “EC Limitation Options” or “ECLOs”). EC Limitation Options may be selected by the author or sender of an EC, other ECLOs may be selected by an individual with authority to impose such selected limitations on ECs authored or sent by one or more users within an organization. Various examples of ECLOs encompassed within this exemplary embodiment of the invention are described in detail in reference to their applicable drawings.

One type of ECLO gives an EC a pre-determined temporal life span (hereinafter referred to as “EC-Temp”). EC-Temp permits a specified time period (“the EC Temporal Life” or “ECTL”) to be assigned to the EC from the time that it is created, sent or observable, after which the EC is automatically deleted from at least one, and as many as all, of the memory locations in which a copy of the EC is electronically stored by a recipient and/or a sender. In other words, after the expiration of the ECTL, the EC can no longer be observed by a user from electronic memory storage medium upon which it was previously stored. In the preferred embodiment, the storage location of all copies of each portion of the EC is overwritten so that the EC could never be retrieved, recovered or restored using forensic software or any other data recovery method.

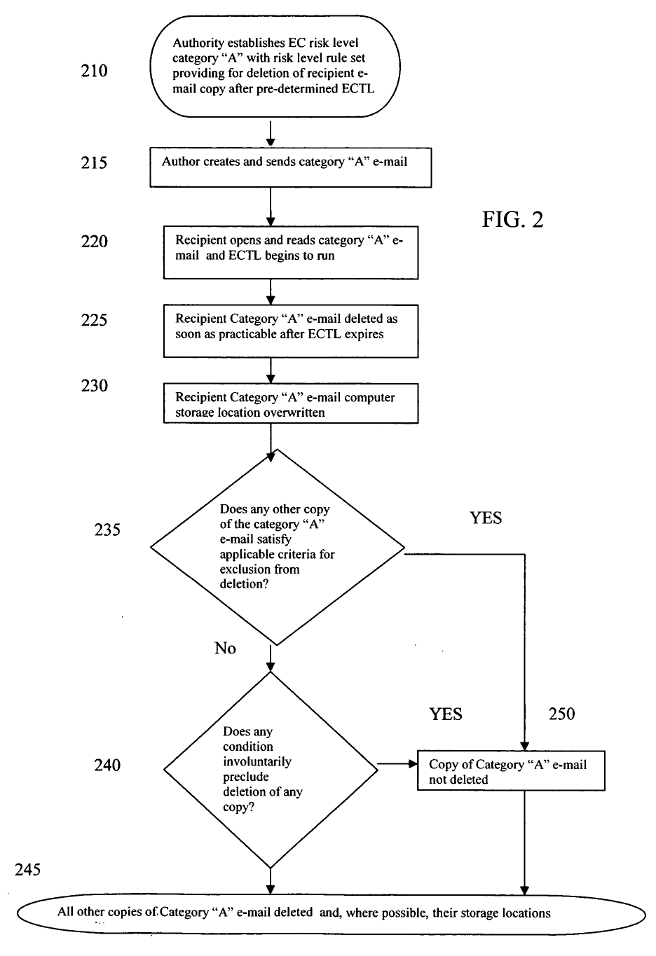

FIG. 2, beginning at Step 210, depicts an embodiment of EC-Temp. By way of example, without limitation, at Step 210, an EC author or a typical company's system administrator may create an EC risk level category “A” for ECs that contain informal communications that need not be saved as a business record of the author or the author's company. The EC risk level rule set assigned to EC risk level category “A” may provide for automatic deletion of a recipient's copy of an e-mail after a pre-determined period of time, i.e. the ECTL. Depending on the preference of the author or the system administrator, the ECTL for a particular EC risk category applying the EC-Temp feature may be set, for example, at 5 minutes, 24 hours, 7 days or one month. The author of the category “A” e-mail sends the e-mail, Step 215. The recipient opens and reads the category “A” e-mail, Step 220. As soon as practicable after expiration of the ECTL, the category “A” e-mail is automatically deleted, Step 225, and is no longer observable. Where possible, the computer storage location from which the e-mail is read by the recipient is overwritten so that the e-mail cannot be recovered, Step 230.

In the embodiment depicted in FIG. 2, the automatic deletion initiated after expiration of the ECTL would apply to all copies of the category “A” e-mail (as would the overwriting feature), wherever they may be electronically stored, Step 245, unless a particular copy or its electronic storage location satisfies any applicable criteria for exclusion from automatic deletion optionally specified in the category “A” risk level category rule set Step 235, or unless some electronic or other condition involuntarily precluded operation of the automatic deletion feature Step 240, in which case the copy would not be deleted, Step 250. An example of a voluntary exclusion from automatic deletion would be where the author desires that the copy of the category “A” e-mail electronically stored on his or her electronic storage media (either internal to his or her computer or external) should not be automatically deleted.

Although the EC-Temp ECLO may be set to mimic an “instant message” generated by an “instant messenger” application by, for example, setting a very short ECTL, the E-Temp ECLO differs from instant messenger applications in the prior art in at least two profound ways: (a) the ECTL duration options are unlimited and can stretch for days, weeks, months or years, and (b) the automatic deletion function of the E-Temp ECLO can apply in an e-mail and other EC applications; it is not limited to an instant messenger application. Indeed, unlike instant messages in the existing art, e-mails and other ECs are actually saved and stored, frequently in multiple places. Instant messages are typically not stored. However, the E-Temp ECLO described herein can be set to include instant messages that are saved, which appear to act more like e-mail.

In another embodiment of the EC-Temp ECLO function, an EC cannot be deleted prior to expiration of the ECTL. Accordingly, an organization may utilize EC-Temp to assist in administering an electronic communication and electronic document retention policy that is part of an overall organizational document retention policy.

In an exemplary embodiment effectuating the document retention policy purpose, a plurality of EC risk level categories would be created, each of which would identify predetermined criteria that would classify ECs based on how long they had to be retained as organization business records. Each of the plurality of EC risk level categories would have an EC risk level rule set providing for automatic deletion of ECs meeting the criteria of such category after expiration of the time that they needed to be maintained pursuant to legal or business requirements, i.e. the EC retention period. Each risk level rule set would set the E-Temp ECLO's ECTL equal to the EC retention period for each of the ECs meeting the criteria of the applicable EC risk level category. By way of example, and without limitation, an EC risk level category could be defined to include ECs that relate to certain auditing functions. The corresponding EC risk level rule set could provide for an E-Temp ECTL being set for the number of years that such an audit-related EC is required to be kept to satisfy legal obligations of applicable statutes and/or regulations (e.g. the Sarbanes-Oxley Act), thus avoiding what could be severe criminal sanctions (e.g. incarceration, monetary fines).

The E-Temp EC retention function could also be utilized to assist in implementing a “litigation hold” that would be necessary if the organization's obligation to retain ECs relevant to a dispute reasonably likely to result in litigation were triggered. By way of example, and without limitation, an EC risk level category could be created that includes ECs authored, sent or received by certain individuals who are key players in the dispute. The applicable risk level rule set would provide for an E-Temp ECTL that would safely exceed the expected duration of the litigation. Thus, the applicable ECs meeting the criteria of the litigation hold EC risk level category would not be able to be intentionally or unintentionally deleted until after the litigation were concluded, thus avoiding civil penalties (e.g. increased risk of losing the case, monetary sanctions, contempt of court).

If the author or system administrator does not want any copies of an EC to be created by any recipient beyond the initial copies received, the EC-One ECLO may be implemented. Indeed, the EC-One ECLO may be implemented in conjunction with the EC-Temp ECLO, as this invention contemplates that a plurality of ECLOs may be applied to a particular risk level category rule set.

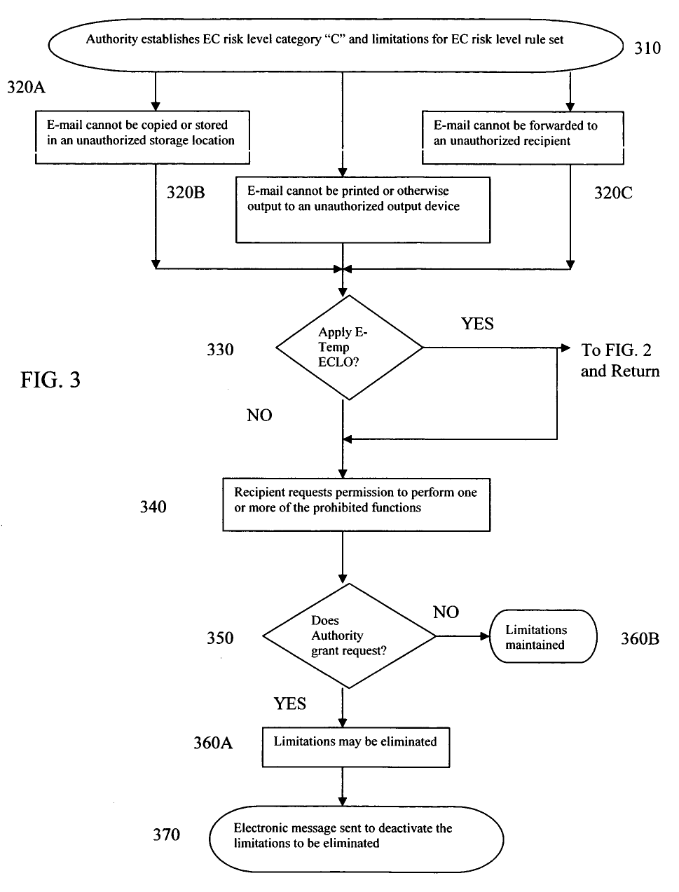

An embodiment of the EC-One ECLO is depicted in Steps 310-370 of FIG. 3. By way of example without limitation, at Step 310, an EC author or system administrator may create an EC risk level category “C” for confidential ECs, the purpose of which might be to limit viewing of the confidential EC to the recipient's eyes only or to a certain group of predetermined, select recipients. At Step 320, the system administrator or EC author can choose among a plurality of limitations to apply to the EC. In the exemplary embodiment, the limitation choices include (i) rendering the EC incapable of being electronically copied (in whole or in part) and stored other than in an authorized storage location, Step 320A, (ii) rendering the EC incapable of being printed to a paper document, Step 320B, and (iii) rendering the EC incapable of being forwarded to an unauthorized or unintended recipient, Step 320C. At Step 330, the EC author or system administrator may decide to also apply the E-Temp ECLO (or any other ECLO), if the EC is so sensitive that it should self-destruct after expiration a predetermined period of time. Optionally, at Step 340, the recipient of the EC may send a request for permission to perform one of the prohibited functions, and at Step 350, the author or system administrator decides whether to deny the request and maintain the limitations, Step 360A, or grant the request and eliminate the prohibitions, 360B. If the request is granted, the applicable limitations may be eliminated by sending a message electronically to the applicable EC's ECLO programming code to deactivate the limitation, Step 370.

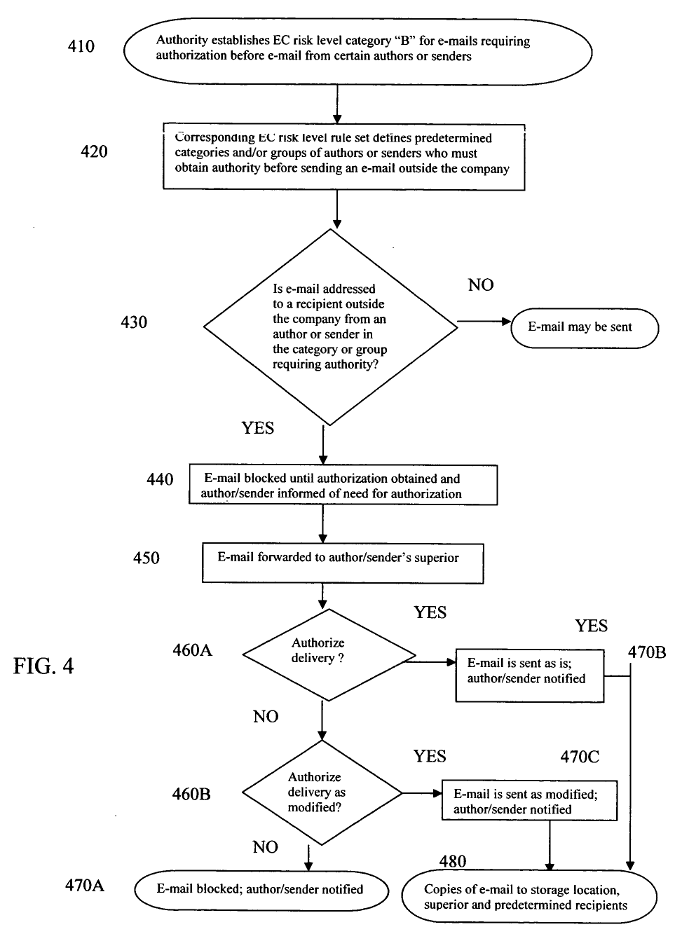

An embodiment of the EC-Block ECLO, which blocks ECs from being sent outside a certain pre-determined domain under any circumstances or until one or more pre-determined conditions are met, is depicted in Steps 410-450 of FIG. 4. By way of example, without limitation, at Step 410, an EC author or system administrator may create an EC risk level category “B” for ECs that must be approved by an authority before they may be sent outside of the company. The corresponding EC risk level rule set may provide that certain predetermined categories and/or groups of authors or senders with insufficient authority to bind the company may not send an e-mail outside of the company unless it has been approved by an authorized company executive who is the author or sender's superior, Step 420. In one embodiment, when an author or sender in the category or group requiring authority intends to send an e-mail outside the company, Step 430, the “to” line in the e-mail is read to determine whether the e-mail is addressed to someone outside the company. If it is, a message informs the author or sender that the e-mail cannot be sent outside the company until one of his or her superiors authorizes it, Step 440. Optionally, the author or sender can provide an explanation to the superior of why authorization should be obtained that is forwarded to the author's superior with the e-mail. The e-mail is then forwarded to the superior, Step 450. The superior then renders a decision Step 460A & 460B, which can be (i) to deny authorization, (ii) to authorize the sending of the e-mail as is, or (iii) to modify the e-mail and authorize the sending as modified. The e-mail (as modified, if applicable) is returned to the author/sender with a message informing the author/sender of the superior's decision either (i) to deny authorization, Step 470A, (ii) to authorize the sending of the e-mail as is Step 470B, or (iii) to authorize the sending of the e-mail as modified, Step 470C. Optionally, the author's superior may prepare an explanation of the superior's decision that is electronically communicated to the author. If the superior denies authorization, the author/sender can resubmit an authorization request to the superior with an explanation of why the sending should be approved, whereupon process repeats at Step 450. If the e-mail is approved for sending either in original form or as modified by the author's superior, (i) the e-mail is sent to the intended recipient outside the company, (ii) the author/sender is notified, and (iii) a copy is forwarded to a predetermined secure data storage location for safekeeping as a company record, as well as optionally, to the authorizing superior and any other predetermined recipients, Step 480.

Each of the ECLOs described above, as well as other ECLO embodiments, may be applied by an EC author or sender to a particular EC or to a plurality of ECs created and/or sent in the absence of an applicable EC risk level category or risk level rule set. Accordingly, even if a system administrator or an author has not created one or more EC risk level categories with a corresponding risk level rule set, an author can apply an ECLO to a single EC such as, for example, EC-One, where he does not want the recipient to be able to copy, forward or print the EC.

Many additional EC risk level categories and corresponding risk level rule sets, as well as many different ECLOs, may be created and maintained for a particular EC system and/or network within the scope and spirit of the invention. The above embodiments are directed to ECRM risk management and mitigation of EC proliferation. However, use of the methodology and structure may be employed in other environments within the scope and spirit of the invention.

In an exemplary embodiment, ECLOs are implemented through software instructions (e.g. program code), attached or otherwise directly or indirectly electronically connected to, or called by, the initially created copy, as well as each subsequently created copy, of the EC to which it applies. Software instructions that enable the computer to perform the operations that implement an ECLO may take the form of program code in any one of a number of programming languages (e.g. JAVA, C++). Such program code may be written by one of ordinary skill in the software arts who has been given the description of the steps comprising each ECLO embodiment as described above and other such ECLO embodiments within the scope and spirit of the invention. ECLO software instructions are capable of being designed and written in a plurality of various ways within the scope and spirit of the invention.

In one embodiment, the software instructions implementing the ECLOs are self-executing; they do not have to be activated or launched by a subsequent action after the EC is sent to a recipient. Moreover, in the preferred embodiment, the software instructions implementing an ECLO applicable to a particular EC or copy thereof cannot be altered or deleted by anyone except for the author, system administrator or other authority that initially implemented the ECLO applicable to said EC or copy thereof.

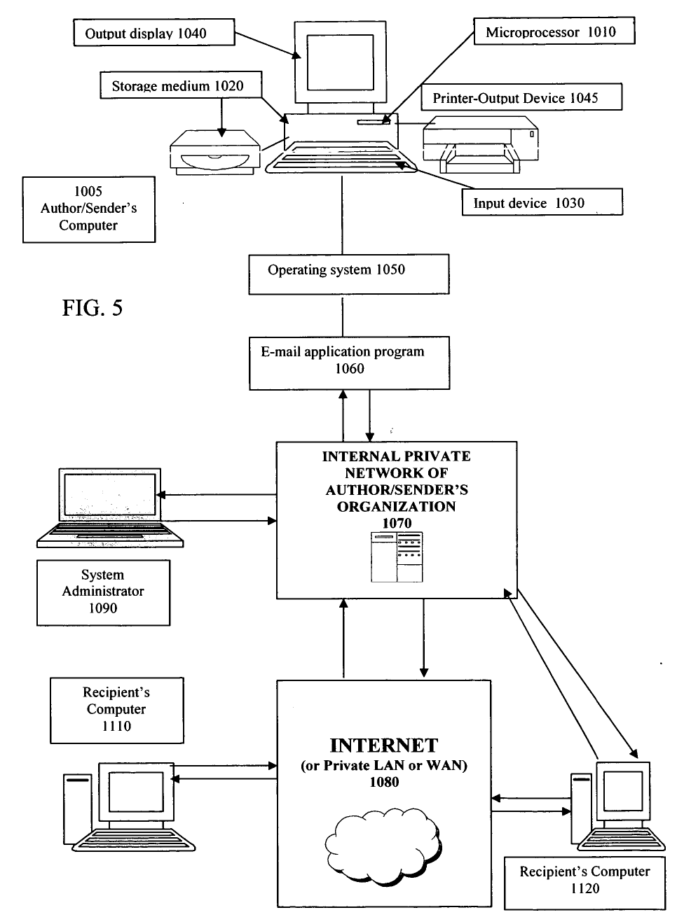

FIG. 5 is block diagram showing the various components of an embodiment of a system that implements ECLOs. At 1005, an author/sender's computer is shown that includes (i) at least one computer processing unit (e.g. microprocessor) 1010, (ii) at least one storage medium (e.g. hard drive) 1020, (iii) at least one input device (e.g. keyboard) 1030, (iv) at least one output display device 1040, and optionally, a printer or other output device 1045, (v) a standard operating system 1050, (vi) a standard e-mail application program 1060, (vii) optionally, a connection to an internal private network of an organization 1070 of which said author/sender is a member or employee and capable of being controlled by at least one system administrator and (viii) a connection to the Internet or private LAN or WAN 1080. At 1110, a recipient's computer is shown that includes (i) at least one computer processing unit (e.g. microprocessor), (ii) at least one storage medium (e.g. hard drive), (iii) at least one input device (e.g. keyboard), (iv) at least one output display device, and optionally, a printer or other output device, (v) a standard operating system, (vi) a standard e-mail application program, and (vii) a connection to the Internet or private LAN or WAN [1080]. At 1120, a second recipient's computer is shown that is connected to the Internet (or private LAN or WAN) 1080 and optionally, the organization's internal private network 1070. Optionally, at 1090, at least one system administrator interfaced with the internal private network of said organization via an electronic device (e.g. computer, terminal, personal digital assistant, telephone) that enables communication with the internal private network of said organization 1070 of which said author is a member or employee, through a computer server or through other means to permit the system administrator to create EC risk level categories and EC risk level rule sets applicable to an EC created by an author within said organization.

In one embodiment, an EC constituting an e-mail created by an author may optionally include one or more electronic document, image or other type of files attached to the EC, referred to as an EC attachment, such as, by way of example, when a word processing document is attached to an e-mail before being transmitted to a recipient. The ECLO program code is attached or otherwise directly or indirectly electronically connected to, or called by, the initially created copy, as well as each subsequently created copy, of the EC to which it applies.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims as may appended and as may be amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the claims as may be appended. The spirit and scope of the appended claims should not be limited to the description of the preferred versions contained herein.

1.-28. (canceled)

29. A method for electronic communication risk management, comprising the steps of:
establishing an electronic communication risk level category with a risk level rule set providing for saving of one or a plurality of copies of electronic communications satisfying one or a plurality of saving criteria until expiration of a predetermined temporal life span; and
precluding the deletion of one or a plurality of copies of electronic communications stored in one or a plurality of electronic storage locations satisfying such saving criteria until such predetermined temporal life span expires.

30. A method for electronic communication risk management, comprising the steps of:
assigning a temporal life span to an electronic communication; and
precluding the deletion of one or a plurality of copies of such electronic communication stored in one or a plurality of electronic storage locations until such predetermined temporal life span expires.

31. A method for electronic communication risk management, comprising the steps of:
establishing an electronic communication risk level category with a risk level rule set providing for saving of one or a plurality of copies of electronic communications satisfying one or a plurality of saving criteria until expiration of a predetermined temporal life span and subsequent deletion thereof;
precluding the deletion of one or a plurality of copies of electronic communications stored in one or a plurality of electronic storage locations satisfying such saving criteria until Such predetermined temporal life span expires; and
deleting automatically one or a plurality of copies of such electronic communications stored in one or a plurality of electronic storage locations after such predetermined temporal life span expires.

32. The method of claim 31, wherein the step of deleting applies to all copies of such electronic communications in all such electronic storage locations in which copies of such electronic communications are stored.

33. The method of claim 31, further comprising:
after the step of deleting, the step of overwriting such one or a plurality of copies of such electronic communications in such electronic storage locations that were deleted to preclude recovery of such electronic communications.

34. The method of claim 32, further comprising:
after the step of deleting, the step of overwriting such one or a plurality of copies of such electronic communications in such electronic storage locations that were deleted to preclude recovery of such electronic communications.

35. A method for electronic communication risk management, comprising the steps of:
assigning a temporal life span to an electronic communication;
precluding the deletion of one or a plurality of copies of such electronic communication stored in one or a plurality of electronic storage locations until such predetermined temporal life span expires; and
deleting automatically one or a plurality of copies of such electronic communication stored in one or a plurality of electronic storage locations after such predetermined temporal life span expires.

36. The method of claim 35, wherein the step of deleting applies to all copies of such electronic communication in all such electronic storage locations in which copies of such electronic communication are stored.

37. The method of claim 35, further comprising:
after the step of deleting, the step of overwriting such one or a plurality of copies of such electronic communication in such electronic storage locations that were deleted to preclude recovery of such electronic communication.

38. The method of claim 36, further comprising:
after the step of deleting, the step of overwriting such one or a plurality of copies of such electronic communication in such electronic storage locations that were deleted to preclude recovery of such electronic communication.

39. A method for electronic communication risk management, comprising the steps of:
establishing a plurality of electronic communication risk level categories, wherein one of said electronic communication risk level categories comprises a risk level rule set providing for one or a plurality of electronic communication limitation options to be applicable to one or a plurality of electronic communications satisfying one or a plurality of limitation criteria; and
applying such one or a plurality of electronic communication limitation options to such one or a plurality of electronic communications.

40. A method for electronic communication risk management, comprising the steps of:
establishing an electronic communication risk level category with a risk level rule set providing for one or a plurality of electronic communication limitation options to be applicable to one or a plurality of electronic communications satisfying one or a plurality of limitation criteria;
identifying one or a plurality of exclusionary criteria for such one or a plurality of such electronic communications satisfying one or a plurality of limitation criteria; and
applying such one or a plurality of electronic communication limitation options to such one or a plurality of electronic communications that do not satisfy such one or a plurality of exclusionary criteria.

41. The method of claim 40, further comprising the steps of:
enabling a recipient of any of such electronic communications to electronically send a request to eliminate certain of such electronic communication limitation options; and
eliminating such certain of such electronic communication limitation options in response to such request.

42. The method of claim 40, further comprising the steps of:
enabling a recipient of any of such electronic communications or another person to electronically send a request to the sender or other authority to eliminate one or more of such electronic communication limitation options; and
eliminating such certain of such electronic communication limitation options in response to such request.

43.-86. (canceled)

87. The method of claim 39,
wherein such one or a plurality of limitation criteria comprise electronic communications originating from one or any of a plurality of predetermined authors or senders; and
wherein such one or a plurality of electronic communication limitation options comprise precluding an intended electronic communication satisfying such limitation criteria from being delivered to potential recipients who are members of a predefined group without prior authorization.

88. The method of claim 87, further comprising the steps of:
requesting, by any of such authors or senders, an authority to authorize delivery of such intended electronic communication to one or more intended recipients who are within such predefined group certain of such potential recipients;
forwarding an electronic copy of such request and such intended electronic communication to such authority;
communicating electronically such authority's response to such author or sender;
delivering such intended electronic communication to such intended recipients if such authority grants such request; and
blocking delivery of such intended electronic communication to such intended recipients if such authority denies such request.

89. The method of claim 87, further comprising the steps of:
requesting electronically, by any of such authors or senders, an authority to give authorization to enable delivery of such intended electronic communications to such intended recipients;
forwarding an electronic copy of such request and such intended electronic communication to such authority;
enabling such authority to modify such intended electronic communication before granting such request;
communicating such authority's response to such author or sender and such authority's modified version of such intended electronic communication to such author or sender;
delivering such intended electronic communication, as modified by such authority, to such intended recipients if such authority grants such request and if such author or sender does not cancel delivery of such intended electronic communication; and
blocking delivery of such intended electronic communication to such intended recipients if such authority denies such request or such author or sender does not cancel delivery of such intended electronic communication.

90. The method of claim 88, further comprising the step of storing a copy of such intended electronic communication delivered to such intended recipients in one or more predetermined storage locations.

91. The method of claim 89, further comprising the step of storing a copy of such intended electronic communication delivered to such intended recipients in one or more predetermined storage locations.

92. The method of claim 90, further comprising the step of forwarding a copy of such intended electronic communication delivered to such intended recipients to predetermined authorized persons.

93. The method of claim 91, further comprising the step of forwarding a copy of such intended electronic communication delivered to such intended recipients to predetermined authorized persons.

94. The method of claim 87, wherein such predefined group contains potential recipients who are outside of such author or sender's organization.

95. The method of claim 87, wherein such predefined group contains potential recipients who are not authorized to receive confidential information of such authors' or senders' organization.

96. The method of claim 87, wherein such predefined group contains potential recipients who are not authorized to receive information from such authors or senders.

97. The method of claim 87, wherein such predefined group contains potential recipients who are not within the department, division or other sub-group of such authors or senders within such authors' or senders' organization.

98-105. (canceled)

106. A method for managing electronic communications comprising:
establishing a plurality of risk level categories for electronic communications;
establishing a risk level rule set for each of said risk level categories, said risk level rule set comprising at least one rule;
generating at least one electronic communication assigned to one of said risk level categories; and
executing at least one rule on said electronic communication in accordance with said risk level rule set associated with said risk level category for said electronic communication.

107. The method as set forth in claim 106, wherein said risk level category for said electronic communications comprises informal electronic communications.

108. The method as set forth in claim 106, wherein said risk level category for said electronic communications comprises a category of electronic communications to be saved for a set period of time.

109. The method as set forth in claim 108, wherein said set period of time corresponds to an audit period.

110. The method as set forth in claim 108, wherein said set period of time corresponds to a litigation hold period.

111. The method as set forth in claim 106, wherein said risk level category for said electronic communications comprises a category of electronic communications that includes confidential communications.

112. The method as set forth in claim 106, wherein said risk level category for said electronic communications comprises a category of electronic communications that identifies a group of individual electronic communication users that have insufficient authority to send electronic communications.

113. The method as set forth in claim 106, wherein said rule for a risk level rule set comprises deleting said electronic communication after a predetermined amount of time.

114. The method as set forth in claim 106, wherein said rule for a risk level rule set comprises saving said electronic communication a predetermined amount of time.

115. The method as set forth in claim 114, wherein said rule for a risk level rule set further comprises deleting said electronic communication after a predetermined amount of time.

116. The method as set forth in claim 106, wherein said rule for a risk level rule set comprises limiting further operation on said electronic communications.

117. The method as set forth in claim 116, wherein said rule for limiting further operation on said electronic communications comprises prohibiting forwarding of said electronic communications.

118. The method as set forth in claim 116, wherein said rule for limiting further operation on said electronic communications comprises prohibiting copying of said electronic communications.

119. The method as set forth in claim 116, wherein said rule for limiting further operation on said electronic communication comprises prohibiting printing of said electronic communications.

120. The method as set forth in claim 116, wherein said rule for limiting further operation on said electronic communication comprises prohibiting saving of said electronic communications.

121. The method as set forth in claim 106, wherein said rule for a risk level rule set comprises excluding one or more electronic communications in said risk level category from operation of said rule based on one or more attributes.

122. The method as set forth in claim 106, wherein said rule for a risk level rule set comprises blocking said electronic communication from exiting a network prior to authorization.

123. A method for managing electronic communications comprising:
establishing a risk level rule set for electronic communications comprising at least one rule;
generating at least one electronic communication assigned to said risk level rule set; and
excluding at least one electronic communications in said risk level category from operation of said rule based on at least one attribute.

124. A method for managing electronic communications comprising:
establishing a risk level rule set for electronic communications comprising at least one rule;
generating at least one electronic communication assigned to said risk level rule set; and
preventing said electronic communication assigned to said risk level rule set from being deleted for a predetermined amount of time in accordance with said rule.

125. The method as set forth in claim 124, wherein said rule for a risk level rule set further comprises deleting said electronic communication after a predetermined amount of time.

126. A computer readable medium comprising a plurality of instructions, which when executed on a computer, causes the computer to perform the steps of:
establishing a plurality of risk level categories for electronic communications;
establishing a risk level rule set for each of said risk level categories, said risk level rule set comprising at least one rule;
generating at least one electronic communication assigned to one of said risk level categories; and
executing at least one rule on said electronic communication in accordance with said risk level rule set associated with said risk level category for said electronic communication.

127. The computer readable medium as set forth in claim 126, wherein said risk level category for said electronic communications comprises informal electronic communications.

128. The computer readable medium as set forth in claim 126, wherein said risk level category for said electronic communications comprises a category of electronic communications to be saved for a set period of time.

129. The computer readable medium as set forth in claim 128, wherein said set period of time corresponds to an audit period.

130. The computer readable medium as set forth in claim 128, wherein said set period of time corresponds to a litigation hold period.

131. The computer readable medium as set forth in claim 126, wherein said risk level category for said electronic communications comprises a category of electronic communications that includes confidential communications.

132. The computer readable medium as set forth in claim 126, wherein said risk level category for said electronic communications comprises a category of electronic communications that identifies a group of individual electronic communication users that have insufficient authority to send electronic communications.

133. The computer readable medium as set forth in claim 126, wherein said rule for a risk level rule set comprises deleting said electronic communication after a predetermined amount of time.

133. The computer readable medium as set forth in claim 126, wherein said rule for a risk level rule set comprises saving said electronic communication a predetermined amount of time.

134. The computer readable medium as set forth in claim 133, wherein said rule for a risk level rule set further comprises deleting said electronic communication after a predetermined amount of time.

135. The computer readable medium as set forth in claim 126, wherein said rule for a risk level rule set comprises limiting further operation on said electronic communications.

136. The computer readable medium as set forth in claim 135, wherein said rule for limiting further operation on said electronic communications comprises prohibiting forwarding of said electronic communications.

137. The computer readable medium as set forth in claim 135, wherein said rule for limiting further operation on said electronic communications comprises prohibiting copying of said electronic communications.

138. The computer readable medium as set forth in claim 135, wherein said rule for limiting further operation on said electronic communication comprises prohibiting printing of said electronic communications.

139. The computer readable medium as set forth in claim 135, wherein said rule for limiting further operation on said electronic communication comprises prohibiting saving of said electronic communications.

140. The computer readable medium as set forth in claim 126, wherein said rule for a risk level rule set comprises excluding one or more electronic communications in said risk level category from operation of said rule based on one or more attributes.

141. The computer readable medium as set forth in claim 126, wherein said rule for a risk level rule set comprises blocking said electronic communication from exiting a network prior to authorization.

142. A computer readable medium comprising a plurality of instructions, which when executed on a computer, causes the computer to perform the steps of:
establishing a risk level rule set for electronic communications comprising at least one rule;
generating at least one electronic communication assigned to said risk level rule set; and
excluding at least one electronic communications in said risk level category from operation of said rule based on at least one attribute.

143. A computer readable medium comprising a plurality of instructions, which when executed on a computer, causes the computer to perform the steps of:
establishing a risk level rule set for electronic communications comprising at least one rule;
generating at least one electronic communication assigned to said risk level rule set; and
preventing said electronic communication assigned to said risk level rule set from being deleted for a predetermined amount of time in accordance with said rule.

144. The computer readable medium as set forth in claim 143, wherein said rule for a risk level rule set further comprises deleting said electronic communication after a predetermined amount of time.

145. A system for managing electronic communications comprising:
network; and
at least one computer, coupled to said network, for establishing a plurality of risk level categories for electronic communications, and for establishing a risk level rule set for each of said risk level categories, said risk level rule set comprising at least one rule, said computer further for generating at least one electronic communication assigned to one of said risk level categories, and for executing at least one rule on said electronic communication in accordance with said risk level rule set associated with said risk level category for said electronic communication.

146. The system as set forth in claim 145, wherein said risk level category for said electronic communications comprises informal electronic communications.

147. The system as set forth in claim 145, wherein said risk level category for said electronic communications comprises a category of electronic communications to be saved for a set period of time.

148. The system as set forth in claim 147, wherein said set period of time corresponds to an audit period.

149. The system as set forth in claim 147, wherein said set period of time corresponds to a litigation hold period.

150. The system as set forth in claim 145, wherein said risk level category for said electronic communications comprises a category of electronic communications that includes confidential communications.

151. The system as set forth in claim 145, wherein said risk level category for said electronic communications comprises a category of electronic communications that identifies a group of individual electronic communication users that have insufficient authority to send electronic communications.

152. The system as set forth in claim 145, wherein said rule for a risk level rule set comprises deleting said electronic communication after a predetermined amount of time.

153. The system as set forth in claim 145, wherein said rule for a risk level rule set comprises saving said electronic communication a predetermined amount of time.

154. The system as set forth in claim 153, wherein said rule for a risk level rule set further comprises deleting said electronic communication after a predetermined amount of time.

155. The system as set forth in claim 145, wherein said rule for a risk level rule set comprises limiting further operation on said electronic communications.

156. The system as set forth in claim 155, wherein said rule for limiting further operation on said electronic communications comprises prohibiting forwarding of said electronic communications.

157. The system as set forth in claim 155, wherein said rule for limiting further operation on said electronic communications comprises prohibiting copying of said electronic communications.

158. The system as set forth in claim 155, wherein said rule for limiting further operation on said electronic communication comprises prohibiting printing of said electronic communications.

159. The system as set forth in claim 155, wherein said rule for limiting further operation on said electronic communication comprises prohibiting saving of said electronic communications.

160. The system as set forth in claim 145, wherein said rule for a risk level rule set comprises excluding one or more electronic communications in said risk level category from operation of said rule based on one or more attributes.

161. The system as set forth in claim 145, wherein said rule for a risk level rule set comprises blocking said electronic communication from exiting a network prior to authorization.

162. A system for managing electronic communications comprising:
network; and
at least one computer, coupled to said network, for establishing a risk level rule set for electronic communications comprising at least one rule, for generating at least one electronic communication assigned to said risk level rule set, and for excluding at least one electronic communications in said risk level category from operation of said rule based on at least one attribute.

163. A system for managing electronic communications comprising:
network; and
at least one computer, coupled to said network, for establishing a risk level rule set for electronic communications comprising at least one rule, for generating at least one electronic communication assigned to said risk level rule set, and for preventing said electronic communication assigned to said risk level rule set from being deleted for a predetermined amount of time in accordance with said rule.

164. The system as set forth in claim 163, wherein said rule for a risk level rule set further comprises deleting said electronic communication after a predetermined amount of time.
